(19) United States
(12) Patent Application Publication
(10) Pub. No.: US 2025/0378286 A1
(43) Pub. Date: Dec. 11, 2025

(54) Application Programming Interfaces For On-Device Speech Services

(71) Applicant: Google LLC, Mountain View, CA (US)

(72) Inventors: Quan Wang, Hoboken, NJ (US); Evan Clark, San Francisco, CA (US); Yang Yu, Millburn, NJ (US); Han Lu, Mountain View, CA (US); Taral Pradeep Joglekar, Sunnyvale, CA (US); Qi Cao, Palo Alto, CA (US); Dharmeshkumar Mokani, Milpitas, CA (US); Diego Melendo Casado, Mountain View, CA (US); Ignacio Lopez Moreno, Brooklyn, NY (US); Hasim Sak, Santa Clara, CA (US)

(73) Assignee: Google LLC, Mountain View, CA (US)

(21) Appl. No.: 19/126,464

(22) PCT Filed: Nov. 23, 2022
(86) PCT No.: PCT/US2022/050854

§ 371 Date: May 1, 2025

(51) Int. Cl. G06F 40/58; G10L 15/00

(52) U.S. Cl. CPC G06F 40/58; G10L 15/005

(57) ABSTRACT

A method (500) includes receiving, from an application (50) executing on a client device (110), at a speech service interface (200), configuration parameters (211) for integrating a speech service (250) into the application. The configuration parameters include a language pack directory (225) that maps a primary language code (235) to an on-device path of a primary language pack (110) of the speech service for use in recognizing speech in a primary language and each of one or more codeswitch language codes to an on-device path. The method also includes receiving audio data (102) characterizing an utterance (106) and processing, using a language ID predictor model (230), the audio data to determine that the audio data is associated with the primary language code. The method also includes processing, using the primary language pack, the audio data to determine a transcription (120) that includes one or more words in the primary language.

### TECHNICAL FIELD

This disclosure relates to application programming interfaces for on-device speech services.

### BACKGROUND

Speech service technologies such as automatic speech recognition are being developed for on-device use where speech recognition models trained via machine learning techniques are configured to run entirely on a client device without the need to leverage computing resources in a cloud computing environment. The ability to run speech recognition on-device drastically reduces latency and can further improve the overall user experience by providing “streaming” capability where speech recognition results are emitted in a streaming fashion and can be displayed for output on a screen of the client device in a streaming fashion. Moreover, many users prefer the ability for speech services to provide multilingual speech recognition capabilities so that speech can be recognized in multiple different languages. Creators of speech services may offer these speech services in the public domain for use by application developers who may want to integrate the use of the speech services into the functionality of the applications. For instance, creators may designate their speech services as open-source. In addition to speech recognition, other types of speech services that developers may want to integrate into the functionality of their application may include speaker labeling (e.g., diarization) and/or speaker change events.

### SUMMARY

One aspect of the disclosure provides a computer-implemented method executed on data processing hardware of a client device that causes the data processing hardware to perform operations that include receiving, from an application executing on the client device, at a speech service interface, configuration parameters for integrating a multilingual speech service into the application. The configuration parameters include a language pack directory that maps: a primary language code to an on-device path of a primary language pack of the multilingual speech service to load onto the client device for use in recognizing speech directed toward the application in a primary language specified by the primary language code; and each of one or more codeswitch language codes to an on-device path of a corresponding candidate language pack. Each corresponding candidate language pack is configured to recognize speech after a switch to a respective particular language specified by the corresponding codeswitch language code is detected by a language identification (ID) predictor model. The operations also include receiving audio data characterizing a first portion of an utterance directed toward the application and processing, using the language ID predictor model, the audio data to determine that the audio data is associated with the primary language code, thereby specifying that the first portion of the utterance includes speech spoken in the primary language. Based on the determination that the audio data is associated with the primary language code, the operations also include processing, using the primary language pack loaded onto the client device, the audio data to determine a first transcription of the first portion of the utterance. The first transcription includes one or more words in the primary language.

Implementations of the disclosure may include one or more of the following optional features. In some implementations, after processing the audio data to determine the first transcription, the operations also include receiving additional audio data characterizing a second portion of the utterance directed toward the application and processing, using the language ID predictor model, the additional audio data to determine that the additional audio data is associated with a corresponding one of the one or more codeswitch language codes, thereby specifying that the second portion of the utterance includes speech spoken in the respective particular language specified by the corresponding codeswitch language code. Based on the determination that the additional audio data is associated with the corresponding codeswitch language code, these operations further include: determining that the additional audio data includes a switch from the primary language to the respective particular language specified by the corresponding codeswitch language code associated with the additional audio data; based on determining that the additional audio data includes the switch from the primary language to the respective particular language, loading, from memory hardware of the client device, using the language pack directory that maps the corresponding codeswitch language code to the on-device path of the corresponding candidate language pack, the corresponding candidate language pack onto the client device for use by the multilingual speech service in recognizing speech in the respective particular language; and processing, using the corresponding candidate language pack loaded onto the client device, the additional audio data to determine a second transcription of the second portion of the utterance, the second transcription including one or more words in the respective particular language specified by the corresponding codeswitch language code associated with the additional audio data.

In some examples, the configuration parameters further include a rewind audio buffer parameter that causes an audio buffer to rewind buffered audio data for use by the corresponding candidate language pack after the switch to the particular language specified by the corresponding codeswitch language code is detected by the language ID predictor model. Additionally or alternatively, the configuration parameters may further include a list of allowed languages that constrains the language ID predictor model to only predict language codes that specify languages from the list of allowed languages. Moreover, the configuration parameters may optionally include a codeswitch sensitivity indicating a confidence threshold that a probability score for a new language code predicted by a language identification (ID) predictor model must satisfy in order for the speech service interface to attempt to switch to a new language pack for recognizing speech in a language specified by the new language code.

In some implementations, each language code and each of the one or more codeswitch language codes specify a respective language and a respective locale. In these implementations, the one or more codeswitch language codes may include a plurality of codeswitch language codes and the respective particular language specified by each codeswitch language code in the plurality of codeswitch language codes may be different than the respective particular language specified by each other codeswitch language code in the plurality of codeswitch language codes. The primary language pack and each corresponding candidate language pack may include at least one of an automated speech recognition (ASR) model, parameters/configurations of the ASR model, an external language model, neural network types, an acoustic encoder, components of a speech recognition decoder, or the language ID predictor model.

In some examples, the configuration parameters also include a speaker change detection mode that causes the multilingual speech service to detect locations of speaker turns in input audio for integration into the application and/or a speaker label mode that causes the multilingual speech service output diarization results for integration into the application, the diarization results annotating a transcription of utterances spoken by multiple speakers with respective speaker labels.

Another aspect of the disclosure provides a system including data processing hardware of a client device and memory hardware in communication with the data processing hardware and storing instructions that when executed on the data processing hardware causes the data processing hardware to perform operations that include that include receiving, from an application executing on the client device, at a speech service interface, configuration parameters for integrating a multilingual speech service into the application. The configuration parameters include a language pack directory that maps: a primary language code to an on-device path of a primary language pack of the multilingual speech service to load onto the client device for use in recognizing speech directed toward the application in a primary language specified by the primary language code; and each of one or more codeswitch language codes to an on-device path of a corresponding candidate language pack. Each corresponding candidate language pack is configured to recognize speech after a switch to a respective particular language specified by the corresponding codeswitch language code is detected by a language identification (ID) predictor model. The operations also include receiving audio data characterizing a first portion of an utterance directed toward the application and processing, using the language ID predictor model, the audio data to determine that the audio data is associated with the primary language code, thereby specifying that the first portion of the utterance includes speech spoken in the primary language. Based on the determination that the audio data is associated with the primary language code, the operations also include processing, using the primary language pack loaded onto the client device, the audio data to determine a first transcription of the first portion of the utterance. The first transcription includes one or more words in the primary language.

This aspect may include one or more of the following optional features. In some implementations, after processing the audio data to determine the first transcription, the operations also include receiving additional audio data characterizing a second portion of the utterance directed toward the application and processing, using the language ID predictor model, the additional audio data to determine that the additional audio data is associated with a corresponding one of the one or more codeswitch language codes, thereby specifying that the second portion of the utterance includes speech spoken in the respective particular language specified by the corresponding codeswitch language code. Based on the determination that the additional audio data is associated with the corresponding codeswitch language code, these operations further include: determining that the additional audio data includes a switch from the primary language to the respective particular language specified by the corresponding codeswitch language code associated with the additional audio data; based on determining that the additional audio data includes the switch from the primary language to the respective particular language, loading, from memory hardware of the client device, using the language pack directory that maps the corresponding codeswitch language code to the on-device path of the corresponding candidate language pack, the corresponding candidate language pack onto the client device for use by the multilingual speech service in recognizing speech in the respective particular language; and processing, using the corresponding candidate language pack loaded onto the client device, the additional audio data to determine a second transcription of the second portion of the utterance, the second transcription including one or more words in the respective particular language specified by the corresponding codeswitch language code associated with the additional audio data.

In some examples, the configuration parameters further include a rewind audio buffer parameter that causes an audio buffer to rewind buffered audio data for use by the corresponding candidate language pack after the switch to the particular language specified by the corresponding codeswitch language code is detected by the language ID predictor model. Additionally or alternatively, the configuration parameters may further include a list of allowed languages that constrains the language ID predictor model to only predict language codes that specify languages from the list of allowed languages. Moreover, the configuration parameters may optionally include a codeswitch sensitivity indicating a confidence threshold that a probability score for a new language code predicted by a language identification (ID) predictor model must satisfy in order for the speech service interface to attempt to switch to a new language pack for recognizing speech in a language specified by the new language code.

In some implementations, each language code and each of the one or more codeswitch language codes specify a respective language and a respective locale. In these implementations, the one or more codeswitch language codes may include a plurality of codeswitch language codes and the respective particular language specified by each codeswitch language code in the plurality of codeswitch language codes may be different than the respective particular language specified by each other codeswitch language code in the plurality of codeswitch language codes. The primary language pack and each corresponding candidate language pack may include at least one of an automated speech recognition (ASR) model, parameters/configurations of the ASR model, an external language model, neural network types, an acoustic encoder, components of a speech recognition decoder, or the language ID predictor model.

In some examples, the configuration parameters also include a speaker change detection mode that causes the multilingual speech service to detect locations of speaker turns in input audio for integration into the application and/or a speaker label mode that causes the multilingual speech service output diarization results for integration into the application, the diarization results annotating a transcription of utterances spoken by multiple speakers with respective speaker labels.

The details of one or more implementations of the disclosure are set forth in the accompanying drawings and the description below. Other aspects, features, and advantages will be apparent from the description and drawings, and from the claims.

### DESCRIPTION OF DRAWINGS

FIGS. 1A and 1B are schematic views of an example system for integrating a multilingual speech service into an application executing on a client device using both application programming interface (API) call configurations and events.

FIG. 2 is a schematic view of an example application executing on a client device providing a set of configuration parameters to a speech service interface for integrating the speech service into the application.

FIG. 3A is a schematic view of an example transcription of an utterance transcribed from audio data using a first speech recognition model for a first language after speech for a different second language is detected in the audio data.

FIG. 3B is a schematic view of the example transcription of FIG. 3A corrected by rewinding buffered audio data to when the speech for the different second language was detected in the audio data and re-transcribing a portion of the utterance by performing speech recognition on the rewound buffered audio data using a second speech recognition model for the second language.

FIG. 4 is a schematic view of various examples for selecting locations to rewind buffered audio data and starting a new speech recognizer for a new language detected in streaming audio captured by a client device.

FIG. 5 is a flowchart of an example arrangement of operations for a method of integrating a multilingual speech service into an application executing on a client device.

FIG. 6 is a schematic view of an example computing device that may be used to implement the systems and methods described herein.

Like reference symbols in the various drawings indicate like elements.

### DETAILED DESCRIPTION

Speech service technologies such as automatic speech recognition are being developed for on-device use where speech recognition models trained via machine learning techniques are configured to run entirely on a client device without the need to leverage computing resources in a cloud computing environment. The ability to run speech recognition on-device drastically reduces latency and can further improve the overall user experience by providing “streaming” capability where speech recognition results are emitted in a streaming fashion and can be displayed for output on a screen of the client device in a streaming fashion. On-device capability also provides for increased privacy since user data is kept on the client device and not transmitted over a network to a cloud computing environment. Moreover, many users prefer the ability for speech services to provide multilingual speech recognition capabilities so that speech can be recognized in multiple different languages. Creators of speech services may offer these speech services in the public domain for use by application developers who may want to integrate the use of the speech services into the functionality of the applications. For instance, creators may designate their speech services as open-source. In addition to speech recognition, other types of speech services that developers may want to integrate into the functionality of their application may include speaker labeling (e.g., diarization) and/or speaker change events.

Implementations herein are directed toward speech service interfaces for integrating one or more on-device speech service technologies into the functionality of an application configured to execute on a client device. Example speech service technologies may be “streaming” speech technologies and may include, without limitation, multilingual speech recognition, speaker turn detection, and or speaker diarization (e.g., speaker labeling). More specifically, implementations herein are directed toward an application providing, as input to a speech service interface, configuration parameters for a speech service and the speech service interface providing events output from the speech service for use by the application. The communication of the configuration parameters and the events between the application and the speech service interface may be facilitated via corresponding application programming interface (API) calls. Other types of software intermediary interface calls may be employed to permit the on-device application to interact with the on-device speech service. For example, the application executing on the client device may be implemented in a first type of code and the speech service may be implemented in a second type of code different than the first type of code, wherein the API calls (or other types of software intermediary interface calls) may facilitate the communication of the configuration parameters and the events between the application and the speech service interface. In a non-limiting example, the first type of code implementing the speech service interface may include one of Java, Kotlin, Swift, or C++ and the second type of code implementing the application may include one of Mac OS, IOS, Android, Windows, or Linux.

The configuration parameters received from the application at the speech service interface may include a language pack directory that maps a primary language code to an on-device path of a primary language pack of the multilingual speech service to load onto the client device for use in recognizing speech directed toward the application in a primary language specified by the primary language code. The same language pack directory or a separate multi-language language pack directory included in the configuration parameters may map each of one or more codeswitch language codes to an on-device path of a corresponding candidate language pack. Here, each corresponding candidate language pack is configured to recognize speech after a switch to a respective particular language specified by the corresponding codeswitch language code is detected by a language identification (ID) predictor model provided by the multilingual speech service and enabled for execution on the client device.

When the application is running on the client device and the client device captures audio data characterizing an utterance of speech directed toward the application (e.g., a voice command instructing the application to perform an action/operation) in a primary language, the language ID predictor model processes the audio data to determine that the audio data is associated with the primary language code and the client device uses the primary language pack loaded thereon to process the audio data to determine a transcription of the utterance that includes one or more words in the primary language.

The speech service interface may provide the transcription emitted from the multilingual speech service as an “event” to the application that may cause the application to display the transcription on a screen of the client device.

Advantageously, the multilingual speech service permits the recognition of codeswitched utterances where the utterance spoken by a user may include speech that codemixes between the primary language and one or more other languages. In these scenarios, the language ID predictor model continuously processes incoming audio data captured by the client device and may detect a codeswitch from the primary language to a particular language upon determining the audio data is associated with a corresponding one of the one or more codeswitch language codes that specifies the particular language. As a result detecting the switch to the new particular language, and based on the language pack directory provided by the configuration parameters, the corresponding candidate language pack for the new particular language loads (i.e., from memory hardware of the client device) onto the client device for use by the multilingual speech service in recognizing speech in the respective particular language. Here, the client device may use the corresponding candidate language pack loaded onto the client device to process the audio data to determine a transcription of the codeswitched utterance that now includes one or more words in the respective particular language.

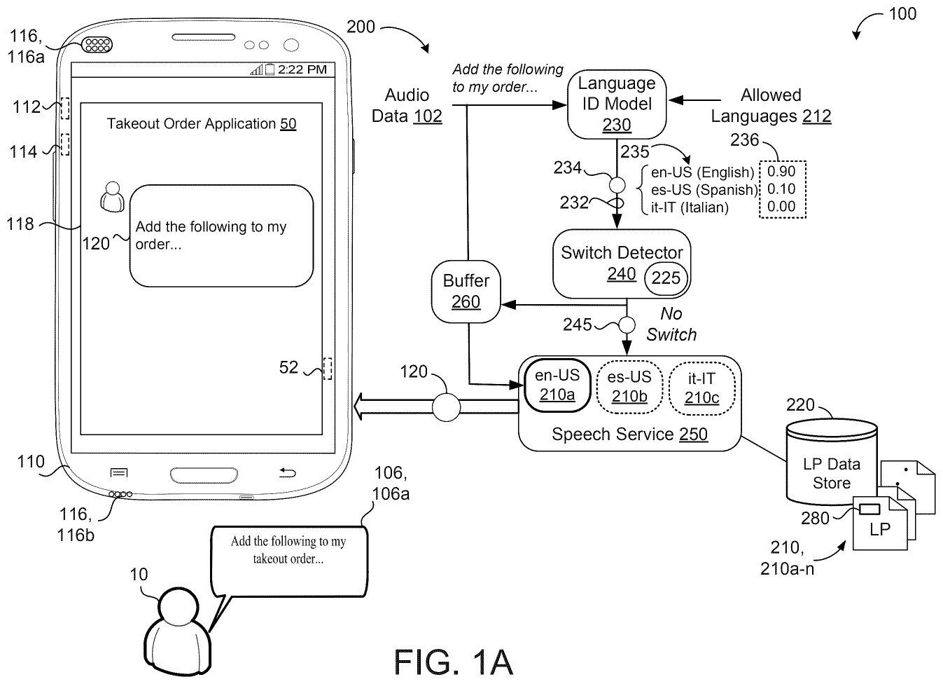

FIGS. 1A and 1B show an example of a system 100 operating in a speech environment. In the speech environment, a user's 10 manner of interacting with a client device, such as a user device 110, may be through voice input. The user device 110 is configured to capture sounds (e.g., streaming audio data) from one or more users 10 within the speech environment. Here, the streaming audio data may refer to a spoken utterance 106 by the user 10 that functions as an audible query, a command for the user device 110, or an audible communication captured by the user device 110. Speech-enabled systems of the user device 110 may field the query or the command by answering the query and/or causing the command to be performed/fulfilled by one or more downstream applications 50.

The user device 110 may correspond to any computing device associated with a user 10 and capable of receiving audio data or other user input. Some examples of user devices 110 include, but are not limited to, mobile devices (e.g., mobile phones, tablets, laptops, etc.), computers, wearable devices (e.g., smart watches, headsets, smart headphones), smart appliances, internet of things (IoT) devices, vehicle infotainment systems, smart displays, smart speakers, etc. The user device 110 includes data processing hardware 112 and memory hardware 114 in communication with the data processing hardware 112 and stores instructions, that when executed by the data processing hardware 112, cause the data processing hardware 112 to perform one or more operations. The user device 110 further includes an audio system 116 with an audio capture device (e.g., microphone) 116, 116a for capturing and converting spoken utterances 106 within the speech environment into electrical signals and a speech output device (e.g., a speaker) 116, 116b for communicating an audible audio signal (e.g., as output audio data from the user device 110). While the user device 110 implements a single audio capture device 116a in the example shown, the user device 110 may implement an array of audio capture devices 116a without departing from the scope of the present disclosure, whereby one or more capture devices 116a in the array may not physically reside on the user device 110, but be in communication with the audio system 116.

The user device 110 may execute a multilingual speech service (MSS) 250 entirely on-device without having to leverage computing services in a cloud-computing environment. By executing the MSS 250 on-device, the multiannual speech service 250 may be personalized for the specific user 10 as components (i.e., machine learning models) of the MSS 250 learn traits of the user 10 through on-going process and update based thereon. On-device execution of the MSS 250 further improves latency and preserves user privacy since data does not have to be transmitted back and forth between the user device 110 and a cloud-computing environment. By the same notion, the MSS 250 may provide streaming speech recognition capabilities such that speech is recognized in real-time and resulting transcriptions are displayed on a graphical user interface (GUI) 118 displayed on a screen of the user device 110 in a streaming fashion so that the user 10 can view the transcription as he/she is speaking. The MSS 250 may provide multilingual speech recognition, speaker turn detection, and or speaker diarization (e.g., speaker labeling). In the example shown, the user device 110 stores a plurality of language packs 210, 210a-n in a language pack (LP) datastore 220 stored on the memory hardware 114 of the user device 110. The user device 110 may download the language packs 210 in bulk or individually as needed. In some examples, the MSS 250 is pre-installed on the user device 110 such that one or more of language packs 210 in the LP datastore 220 are stored on the memory hardware 114 at the time of purchase.

In some examples, each language pack (LP) 210 includes resource files configured to recognize speech in a particular language. For instance, one LP 210 may include resource files for recognizing speech in a native language of the user 10 of the user device 110 and/or the native language of a geographical area/local the user device 110 is operating. Accordingly, the resource files of each LP 210 may include one or more of a speech recognition model, parameters/configuration settings of the speech recognition model, an external language model, neural networks, an acoustic encoder (e.g., multi-head attention/based, cascaded encoder, etc.), components of a speech recognition decoder (e.g., type of prediction network, type of joint network, output layer properties, etc.), or a language identification (ID) predictor model 230. In some examples, one or more of the LPs 210 include a speaker change/labeling model 280 that is configured to detect speaker change events and/or diarization result events.

An operating system 52 of the user device 110 may execute a software application 50 on the user device 110. The user device 110 use a variety of different operating systems 52. In examples where a user device 110 is a mobile device, the user device 110 may run an operating system including, but not limited to, ANDROID® developed by Google Inc., IOS® developed by Apple Inc., or WINDOWS PHONE® developed by Microsoft Corporation. Accordingly, the operating system 52 running on the user device 110 may include, but is not limited to, one of ANDROID®, IOS®, or WINDOWS PHONE®. In some examples a user device may run an operating system including, but not limited to, MICROSOFT WINDOWS® by Microsoft Corporation, MAC OS® by Apple, Inc., or Linux.

A software application 50 may refer to computer software that, when executed by a computing device (i.e., the user device 110), causes the computing device to perform a task. In some examples, the software application 50 may be referred to as an “application”, an “app”, or a “program”. Example software applications 50 include, but are not limited to, word processing applications, spreadsheet applications, messaging applications, media streaming applications, social networking applications, and games. Applications 50 can be executed on a variety of different user devices 110. In some examples, applications 50 are installed on the user device 50 prior to the user 10 purchasing the user device 50. In other examples, the user 10 may download and install applications 50 on the user device 110.

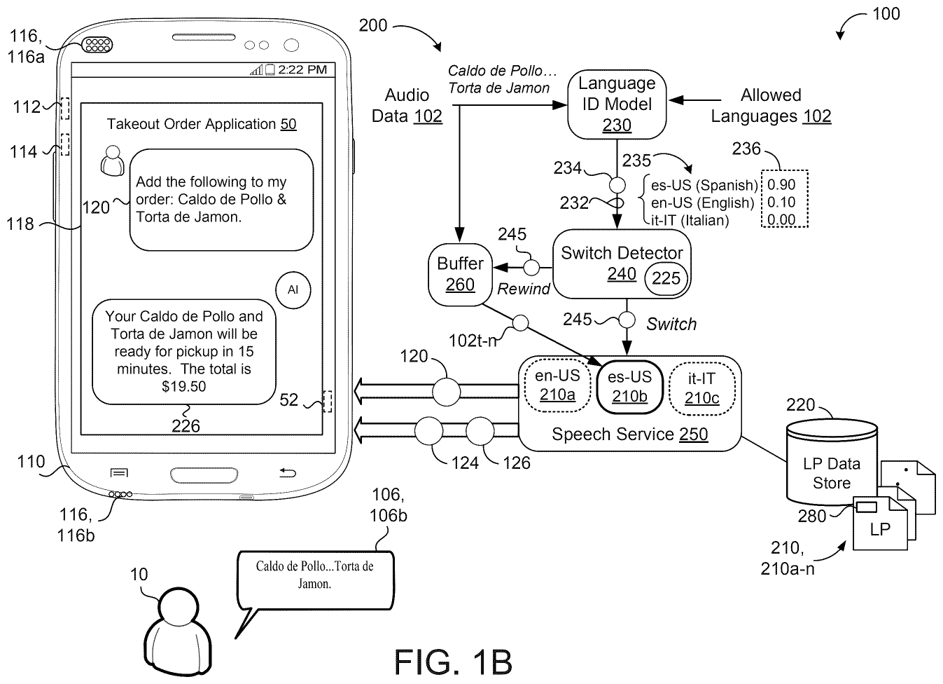

Implementations herein are directed toward the user device 110 executing a speech service interface 200 configured to receive configuration parameters 211 (FIG. 2) from the software application 50 for integrating the functionality of the MSS 250 into the software application 50 executing on the user device 110. In some examples, the speech service interface 200 includes an open-sourced API that is visible to the public to allow application developers to integrate the functionality of the MSS 250 into their applications. In the example shown, the application 50 includes a meal takeout application 50 that provides a service to allow the user 10 to place orders for takeout meals from a restaurant. More specifically, the speech service interface 200 integrates the functionality of the MSS 250 into the application 50 to permit the user 10 to interact with the application 50 through speech such that the user 10 can provide spoken utterances 106 to place a meal order in an entirely hands free manner. Advantageously, the MSS 250 may recognize speech in multiple languages and be enabled for recognizing codeswitched speech where the user speaks an utterance in two or more different languages. For instance, the meal takeout application 50 may allow the user 10 to place orders for takeout meals through speech (i.e., spoken utterances 106) from El Barzon, a restaurant located in Detroit, Michigan that specializes in upscale Mexican and Italian fare dishes. While the user 10 may speak English as a native language (or it can be generally assumed that users using the application 50 for the Detroit-based restaurant are native speakers of English), the user 10 is likely to speak Spanish words when selecting Mexican dishes and/or Italian words when selecting Italian dishes to order from the restaurant's menu.

FIG. 2 shows a schematic view of the speech service interface 200 receiving a plurality of configuration parameters 211 from an application 110 executing on a user device to integrate functionality of the multilingual speech service 250 into the application 110. The configuration parameters 211 may include a set of one or more language ID/multilingual configuration parameters and/or a set of one or more speaker change/labeling configuration parameters. The application 110 may provide the configuration parameters 211 to the speech service interface 200 as an input API call. The application 110 may provide configuration parameters 211 on an ongoing basis and may change values for some configuration parameters 211 based on any combination of user inputs, changes in user context/and/or changes in ambient context.

The configuration parameters 211 may include a language pack directory 225 (FIGS. 1A and 1B) that maps a primary language code 235 to an on-device path of a primary language pack 210 of the multilingual speech service 225 to load onto the user device 110 for use in recognizing speech directed toward the application 50 in a primary language specified by the primary language code 235. In short, the language pack directory 225 contains the path to all the necessary resource files stored on the memory hardware 114 of the user device 110 for recognizing speech in particular language. In some examples, the configuration parameters 211 explicitly enable multi-language speech recognition by specifying the primary language code 235 for a primary locale within the language pack directory 225. When multi-language speech recognition is enabled, the language pack directory 225 may also map each of one or more codeswitch language codes 235 to an on-device path of a corresponding candidate language pack 210. Here, each corresponding candidate language pack 210 is configured to recognize speech after a switch to a respective particular language specified by the corresponding codeswitch language code 235 is detected by a language identification (ID) predictor model 230. In some examples, the language pack directory 225 provides an on-device path of the language pack 210 that contains the language ID predictor model 230. The application may provide the language pack directory 225 based on a geographical area the user device 110 is located, user preferences specified in a user profile accessible to the application, or default settings of the application 50.

The language ID predictor model 230 may support identification of a multitude of different languages from input audio data. The present disclosure is not limited to any specific language ID predictor model 230, however the language ID predictor model 230 may include a neural network trained to predict a probability distribution over possible languages for each of a plurality of audio frames segmented from input audio data 102 and provided as input to the language ID predictor model 230 at each of a plurality of time steps. In some examples, the language codes 115 are represented in BCP 47 format (e.g., en-US, es-US, it-IT, etc.) where each language code 11 specifies a respective language (e.g., en for English, es for Spanish, it for Italian, etc.) and a respective local (e.g., US for United States, IT for Italy, etc.). In some implementations, when the configuration parameters 211 enable multi-language speech recognition, the respective particular language specified by each codeswitch language code 235 supported by the language ID predictor model 230 is different that the respective particular language specified by each other codeswitch language code in the plurality of codeswitch language codes 115. Each language pack 210 referenced by the language pack directory 225 may be associated with a respective one of the language codes 115 supported by the language ID predictor model 230. In some examples, the speech service interface 200 permits the language codes 115 and language packs 210 to only include one locale per language (e.g., only es-US not both es-US and es-ES).

In some examples, the configuration parameters 211 received at the speech service interface 200 also include a list of allowed languages 212 that constrains the language ID predictor model 230 to only predict language codes 115 that specify languages from the list of allowed languages 212. Thus, while the language ID predictor model 230 may support a multitude of different languages, the list of allowed languages 212 optimizes performance of the language ID predictor model 230 by constraining the model 210 to only consider language predations for those languages in the list of allowed languages 210 rather than each and every language supported by the language ID predictor model 230. For instance, in the example of FIGS. 1A and 1B where the application 50 includes the meal takeout application for ordering Mexican and Italian meals from El Barzon restaurant, the application 50 may provide a list of allowed languages 212 as a configuration parameter 211 where the list of allowed languages 212 includes English, Spanish, and Italian. Here, application 50 may designate Spanish and Italian as allowed languages based on the Mexican and Italian meal items available for order having Spanish and Italian names. On the other hand, the application 50 may designate English as an allowed language since the user 10 speaks English as a native language. However, if the application 50 ascertained from user profile settings of the user device 110 that the user 10 is a bilingual speaker of both English and Hindi, the application 50 may also designate Hindi as an additional allowed language. By the same notion, when the same meal takeout application 50 is executing on a different user device associated with another user who only speaks Spanish, the application 50 may provide configuration parameters 211 that include a list of allowed languages that only includes Spanish and Italian.

In some configurations, the language ID predictor model 230 is configured to provide a probability distribution 234 (FIGS. 1A and 1B) over possible language codes 115. Here, the probability distribution 234 is associated with a language ID event and includes a probability score 236 (FIGS. 1A and 1B) assigned to each language code indicating a likelihood that the corresponding input audio frame 102 corresponds to the language specified by the language code 235. As described in greater detail below with reference to FIGS. 1A and 1B, the language ID predictor model 230 may rank the probability distribution 234 over possible languages 115 and a language switch detector 240 may predict a codeswitch to a new language when a new language code 235 is ranked highest and its probability score 236 satisfies a confidence threshold. In some scenarios, the language switch detector 220 defines different magnitudes of confidence thresholds to determine different levels of confidence in language predictions of each audio frame 102 input to the language ID predictor model 230. For instance, the language switch detector 220 may determine that a predicted language for a current audio frame 102 is highly confident when the probability score 236 associated with the language code 235 specifying the predicted language satisfies a first confidence threshold or confident when the probability score satisfies a second confidence threshold having a magnitude less than the first confidence threshold. Additionally, the language switch detector 220 may determine that the predicted language for the current audio frame 102 is less confident when the probability score satisfies a third threshold having a magnitude less than both the first and second confidence thresholds. In a non-limiting example, the third confidence threshold may be set at 0.5, the first confidence threshold may be set at 0.85, and the second confidence threshold may be set at some value having a magnitude between 0.5 and 0.85.

In some implementations, the configuration parameters 211 received at the speech service interface 200 also include a codeswitch sensitivity indicating a confidence threshold that a probability score 236 for a new language code 235 predicted by the language ID predictor model 230 in the probability distribution 234 must satisfy in order for the speech service interface 200 to attempt to switch to a new language pack. Here, the codeswitch sensitivity includes a value to indicate the confidence threshold that the probability score 236 must satisfy in order for the language switch detector 240 (FIGS. 1A and 1B) to attempt switch to the new language pack by loading the new language pack 210 into an execution environment for performing speech recognition on the input audio data 102. In some examples, the value of the codeswitch sensitivity includes a numerical value that must be satisfied by the probability score 236 associated with the highest ranked language code 235. In other examples, the value of the codeswitch sensitivity is an indication of high precision, balanced, or low reaction time each correlating to a level of confidence associated with the probability score 236 associated with the highest ranked language code 235. Here, a codeswitch sensitivity set to ‘high precision’ optimizes the speech service interface 200 for higher precision of the new language code 235 such that speech service interface 200 will only make the attempt to switch to the new language pack 210 when the corresponding probability score 236 is highly confident. The application 50 may set the codeswitch sensitivity to ‘high precision’ by default where false-switching to the new language pack would be annoying to the end user 10 and slow-switching is acceptable. Setting the codeswitch sensitivity to ‘balanced’ optimizes the speech service interface 200 to balance between precision and reaction time such that the speech service interface 200 will only attempt to switch to the new language pack 210 when the corresponding probability score 236 is confident.

Conversely, in order to optimize for low reaction time, the application 50 may set the codeswitch sensitivity to ‘low reaction time’ such that the speech service interface 200 will attempt to switch to the new language pack regardless of confidence as long as the highest ranked language code 235 is different than the language code 235 that was previously ranked highest in the probability distribution 234 (i.e., language id event) output by the language ID predictor model 235. The application 50 may set the codeswitch sensitivity to ‘low reaction time’ when slow switches to new language packs are not desirable and false-switches are acceptable. The application 50 may provide configuration parameters 211 periodically to update the codeswitch sensitivity. For instance, a high frequency of user corrections may fixing false-switching events may cause the application 50 to increase the codeswitch sensitivity to reduce the occurrence of future false-switching events at the detriment of increased reaction time.

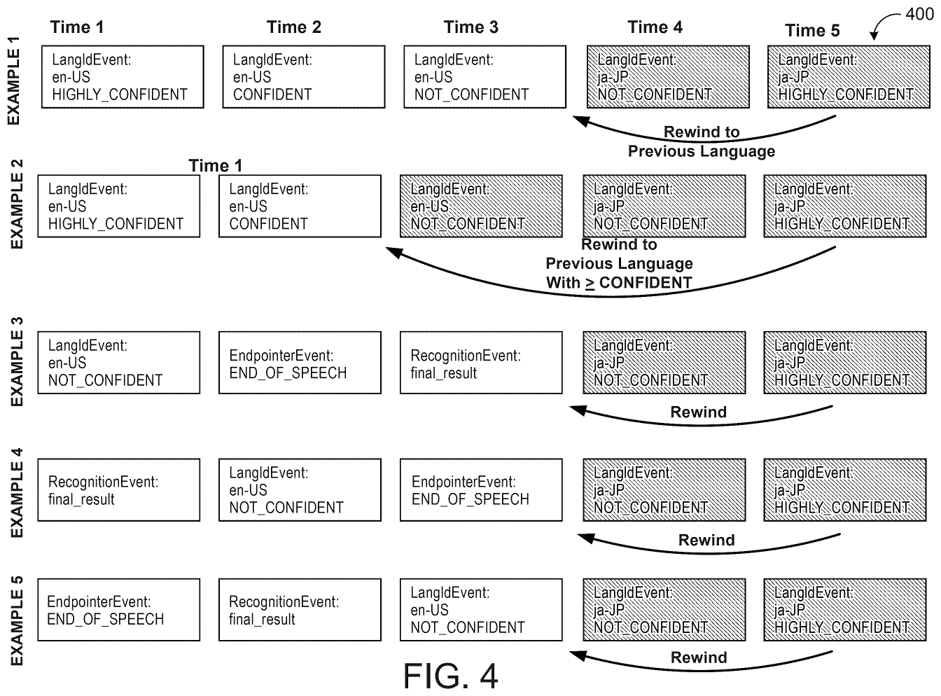

When the speech service interface 200 decides (i.e., based on a switching decision 245 output by the language switch detector 240 of FIGS. 1A and 1B) to switch to a new language pack 210 for recognizing speech, there may be a delay in time for the speech service interface 200 to load the new language pack 210 into the execution environment for recognizing speech in the new language. As a result of this delay, MSS 250 may continue to use the language pack 210 associated with the previously identified language to process the input audio data 102 until the switch to the correct new language pack 210 is complete, thereby resulting in recognition of words in an incorrect language. Furthermore, the language ID predictor model 230 may take a few seconds to accumulate enough confidence in probability scores for new language codes ranked highest in the probability distribution 234. To account for the delay in the time it takes for the speech service interface 200 to load the new language pack 210 into the execution environment, the application 50 may enable a rewind audio buffer parameter as one of the configuration parameters 211 provided to the speech service interface 200. Described in greater detail below with reference to FIGS. 1A, 1B, and 4, the rewind audio buffer parameter causes an audio buffer 260 (FIGS. 1A and 1B) to rewind buffered audio data relative to a time when the language ID predictor model 210 predicted the new language code 215 associated with a new language pack 210 the speech service interface 200 is switching to so that the new language pack 210 for the correct language can commence processing the rewound buffered audio data once the switch to the new language pack 210 is complete (i.e., successfully loaded).

The rewind buffered audio parameter may consider how long the audio buffer 260 should rewind buffered audio data since long rewinds require larger storage costs in order to buffer larger audio files, while shorter rewinds may not capture words spoken in the new language. The rewind buffered audio parameter may specify a value of max buffer size such that if switching to a new language pack 210 occurs within X seconds, the max buffer size for the audio buffer can be set to X+1 seconds. In some examples, the value of X does not exceed a number of seconds (e.g., 10 seconds) for which the language ID predictor model 230 resets its states.

For applications 50 where input utterances to be recognized are relatively short, incorrectly recognizing words due to using the previous language pack 210 before a switch to a new language pack 210 is complete may be equivalent to misrecognizing the entire utterance. Similarly, in an application 50 such as an open-mic translation application translating utterances captured in a multilingual conversation, recognizing words in a wrong language during each speaker turn can add up to a lot of misrecognized words in the entire conversation.

Referring to the schematic view 400 of FIG. 4, examples 1 and 2 depict locations to rewind buffered audio data that are selected based on codeswitching events to a new language pack 210 by the speech service interface 200. As used herein, a codeswitching event indicates when the highest ranked language code 235 predicted by the language ID predictor model 230 for a current audio frame 102 is different than the highest ranked language code 235 predicted for an immediately previous audio frame 102. As such, a codeswitching event does not necessary indicate a switch decision where the speech service interface 200 makes a switch to a new language pack 210 that maps to the new highest ranked language code 235. As discussed above, switching decisions may be based on a value of the codeswitching sensitivity set by the application 50 in the configuration parameters 211 provided to the speech service interface 200.

Each block may represent a language ID event 232 (FIGS. 1A and 1B) indicating a predicted language for the audio frame 102 at a corresponding time (Time 1, Time 2, Time 3, Time 4, and Time 5) and a level of confidence of the probability score 236 for the corresponding highest ranked language code 235 in the probability distribution 234 that specifies the predicted language. For instance, at Time 1-3, the predicted language for the corresponding audio frames 102 is Spanish as specified by the highest ranked language code 235 of en-ES. Notably, Examples 1 and 2 show that the confidence of the language prediction gradually decreases between Times 1-3 based on the level of confidence for the probability score 236 determined to be ‘Highly Confident’ (e.g., the probability score 236 satisfies a first confidence threshold value) at Time 1, ‘Confident’ (e.g., the probability score 236 satisfies a second confidence threshold value but fails to satisfy the first confidence threshold value) at Time 2, and ‘Not Confident’ (e.g., the probability score 226 satisfies a third confidence threshold value but fails to satisfy the first and second confidence threshold values) at Time 3.

Still referring to Examples 1 and 2 of FIG. 4, the language ID events 232 at Times 4 and 5 indicate that the predicted language for the corresponding audio frames 102 is now Japanese as specified by the highest ranked language code 235 of jp-JP. Here, the confidence of the language prediction for Japanese gradually increases from Time 4 to Time 5 based on the level of confidence of the probability score 236 for the language code 235 of jp-JP determined to be ‘Not Confident’ (e.g., the probability score 236 satisfies the third confidence threshold value but does not satisfy either of the first and second confidence threshold values) at Time 4 and ‘Highly Confident’ (e.g., the probability score 236 satisfies the second confidence threshold value) at Time 5. In some examples, the speech service interface 200 ensures to never rewind buffered audio data prior to a location (e.g., Time) where the language ID event 234 still predicted the previous language. For instance, Example 1 shows that the speech service interface 200 rewinds buffered audio data to the location between Times 3 and 4 where the codeswitching event from Spanish to Japanese occurs even though the level of confidence of the probability scores 236 for the highest ranked language codes 234 of en-US and jp-JP at Time 3 and 4, respectively, were each determined to be ‘Not Confident’. On the other hand, Example 2 shows the speech service interface 200 rewinding buffered audio data to a location between Times 2 and 3 where the language ID event 232 still predicts the previous language (e.g., Spanish) but the level of confidence of the probability score 236 for the language code 235 of en-US transitions from ‘Confident’ to ‘Not Confident’. With continued reference to FIGS. 2 and 4, in some implementations, the

configuration parameters 211 constrain the speech service interface 200 to never rewind buffered audio data prior to times where an endpointer detected an end of speech event at some point in the middle of the buffered audio data. Additionally or alternatively, the configuration parameters 211 may constrain the speech service interface 200 to never rewind buffered audio data prior to a time where a final ASR result event determined by the previous language pack 210. Examples 3-5 of FIG. 4 all show the speech service interface 200 rewinding buffered audio data to a location prior to Time 4 where the previous language (e.g., English) was last predicted but after an end of speech event detected by the endpointer and a final ASR result event determined by the previous language pack 210.

Referring back to FIG. 2, the application 50 may additionally provide configuration parameters 211 to the speech service interface 200 that include a speaker mode parameter to integrate speaker change detection or speaker labeling functionality of the MSS 250 into the application 50. For instance, the speaker mode parameter may include a value specifying to enable speaker change detection mode to cause the MSS 250 to detect locations of speaker turns in the input audio data for integration into the application 50. The application 50 may receive the speaker change detection locations as an output API call event from the speech service interface 200. The configuration parameters 211 for enabling the speaker change detection mode may further provide an on-device path that maps to language packs 210 having speaker change/labeling models 280. In some examples, a transcription 120 output by the MSS 250 for an utterance directed toward the application 50 may be annotated with the locations where the speaker turns occur.

Similarly, the speaker mode parameter may include a value specifying to enable speaker labeling (e.g., diarization) to cause the MSS 250 to output diarization results for integration into the application 50. Here, the value enabling speaker labeling may further require the application to provide configuration parameters with values specifying both minimum and maximum numbers of speakers for speaker diarization. By default, the application 50 may set the minimum number of speakers to a value equal to two (2) and the maximum number of speakers to a value greater than or equal to two (2).

In some examples, a user 10 of the application 50 may indicate the maximum number of speakers for speaker diarization. In additional examples, a context of the application 50 may indicate the maximum number of speakers for speaker diarization. For instance, in an example where the application 50 is a video call application that transcribes utterances spoken by meeting participants in real time, the application 50 may set the maximum number of speakers based on the number of participants in the current video call session.

Referring back to FIGS. 1A and 1B, the configuration parameters 211 input to the speech service interface 200 may cause the speech service interface to load an en-US language pack as a primary language pack 210a for use in recognizing speech directed toward the application 50 in the primary language of English. Notably, the primary language pack 210a is depicted as a dark solid line in FIG. 1A to indicate that the primary language pack 210a is loaded into an execution environment for recognizing incoming audio data 102. The candidate language packs 210b, 210c for Spanish and Italian, respectively are depicted as dashed lines to indicate that the candidate language packs 210b, 210c are currently not loaded in FIG. 1A. FIG. 1B depicts the candidate language pack 210b for recognizing speech in Spanish as a dark solid line to indicate that speech service interface 200 made a switching decision to now load the candidate language pack 210b, the primary language pack 210a and the other candidate language pack 210c are depicted as dashed lines to indicate they are not currently loaded for recognizing input audio data 102. Moreover, while the language ID predictor model 230 is shown as separate component from the language packs 210 of the MSS 250 for simplicity, one or more of the language packs 210 may include the language ID predictor model 230 as a resource.

FIG. 1A shows the user 10 speaking a first portion 106a of an utterance 106 that is directed toward the meal takeout application 50 that includes the user 10 speaking

“Add the following to my takeout order . . . ” in English. The user device 110 captures the audio data 102 characterizing the first portion 106a of the utterance 106. The audio data 102 may include a plurality of audio segments or audio frames that may be each provided as input to the MSS 250 at a corresponding time step. The language ID predictor model 230 processes the audio data 102 to determine whether or not the audio data 102 is associated with the primary language code 235 of en-US. Here, the language ID predictor model 230 may process the audio data 102 at each of a plurality of time steps to determine a corresponding probability distribution 234 over possible language codes 235 at each of the plurality of time steps.

In the example shown, the configuration parameters 211 may include a list of allowed languages 212 that constrains the language ID predictor model 230 to only predict language codes 235 that specify languages from the list of allowed languages 212. For instance, when the list of allowed languages 212 includes only English, Spanish, and Italian, the language ID predictor model 230 will only determine a probability distribution 234 over possible language codes 235 that include English, Spanish, and

Italian. The probability distribution 234 may include a probability score 236 assigned to each language code 235. In some examples, the language ID predictor model 230 outputs the language ID event 232 indicating a predicted language for the audio frame 102 at the corresponding time and a level of confidence of the probability score 236 for the corresponding highest ranked language code 235 in the probability distribution 234 that specifies the predicted language. In the example shown, primary language code 235 of en-US is associated with a highest probability score in the probability distribution 234. A switch detector 240 receives the language ID event 232 and determines that the audio data 102 characterizing the utterance “Add the following to my order” is associated with the primary language code 235 of en-US. For instance, the switch detector 240 may determine that the audio data 102 is associated with the primary language code 235 when the probability score 236 for the primary language code 235 satisfies a confidence threshold. Since the switch detector 240 determines the audio data 102 is associated with the primary language code 235 that maps to the primary language pack 210a currently loaded for recognizing speech in the primary language, the switch detector 240 outputs a switching result 245 of No Switch to indicate that the current language pack 210a should remain loaded for use in recognizing speech. Notably, the audio data 102 may be buffered by the audio buffer 260 and the speech service interface may rewind the buffered audio data in scenarios where the switching result 245 includes a switch decision. FIG. 1A shows the speech service interface 120 providing a transcription 120 of the first portion 106a of the utterance 106 in English to the application 50. The application 50 may display the description 120 on the GUI 118 displayed on the screen of the user device 110.

FIG. 1B shows the user 10 speaking a second portion 106b of the utterance 106 that includes “Caldo de Pollo. . . . Torta de Jamon” that includes Spanish words for Mexican dishes the user 10 is selecting to order from the restaurant's menu. The user device 110 captures additional audio data 102 characterizing the second portion 106b of the utterance 106 and the language ID predictor model 230 processes the additional audio data 102 to determine a corresponding probability distribution 234 over possible language codes 235 at each of the plurality of time steps. More specifically, the language ID predictor model 230 may output the language ID event 232 indicating a predicted language for the additional audio data at the corresponding time and a level of confidence of the probability score 236 for the corresponding highest ranked language code 235 in the probability distribution 234 that specifies the predicted language. Notably, the language ID event 232 associated with the additional audio data now indicates that the codeswitch language code 235 for es-US is ranked highest in the probability distribution 234.

The switch detector 240 receives the language ID event 232 for the additional audio data and determines that the additional audio data 102 characterizing the second portion 106b of the utterance “Caldo de Pollo . . . Torta de Jamon” is associated with the codeswitch language code 235 of es-US. For instance, the switch detector 240 may determine that the additional audio data 102 is associated with the codeswitch language code 235 when the probability score 236 for the codeswitch language code 235 satisfies the confidence threshold. In some examples, a value for codeswitch sensitivity provided in the configuration parameters 211 indicates a confidence threshold that the probability score 236 for the codeswitch language code 235 must satisfy in order for the switch detector 240 to output a switch result 245 indicative of a switching decision (Switch). Here, the switch result 245 indicating the switching decision causes the speech service interface 200 to attempt to switch to the candidate language pack 210b for recognizing speech in the particular language (e.g., Spanish) specified by the codeswitch language code 235 of es-US.

The speech service interface 200 switches from the primary language pack 210a to the candidate language pack 210b for recognizing speech in the respective particular language by loading, from the memory hardware 114 of the user device 110, using the language pack directory 225 that maps the corresponding codeswitch language code 235 to the on-device path of the corresponding candidate language pack 210b of es-US, the corresponding candidate language pack 210b onto the user device 110 for use in recognizing speech in the respective particular language of Spanish. FIG. 1B shows the speech service interface 100 providing a transcription 120 of the second portion 106b of the utterance 106 in Spanish to the application 50. The application 50 may display update the transcription 120 displayed the GUI 118 to provide a final transcription that includes the entire codemixed utterance of Add the following to my order: Caldo de Pollo & Torta de Jamon. Notably, the speech service 250 may perform normalization on the final transcription 120 to add capitalization and punctuation.

The language ID event 232 output by the language ID predictor model 230, the switch result 245 output by the switch detector 240, and the transcription 120 output by the MMS 250 may all include corresponding events that the speech service interface 200 may provide to the application 50. In some examples, the speech service interface 200 provides one or more of the aforementioned events 234, 245, 120 as corresponding output API calls.

In the example of FIG. 1B, since the speech service interface 200 decides (i.e., based on the switch result 245 indicative of the switching decision output by the language switch detector 240) to switch to the new candidate language pack 210b for recognizing speech in the respective particular language (e.g, Spanish), there may be a delay in time for the speech service interface 200 to load the new candidate language pack 210b for es-US into the execution environment for recognizing speech in Spanish. To account for this delay, the switching decision specified by the switch result 245 may cause the audio buffer 260 to rewind buffered audio data 102t-1 relative to a time when the language ID predictor model 210 predicted the codemixed language code 215 associated with the candidate language pack 210 the speech service interface 200 is switching to for recognizing speech in the correct language (e.g., Spanish). The audio buffer 260 may rewind the buffered audio data 102t-1 to any of the locations described above with reference to FIGS. 2 and 4. Accordingly, the speech service interface 200 may retrieve the buffered audio data 102t-1 for use by the candidate language pack 210b once the switch to the candidate language pack 210b is complete (i.e., successfully loaded).

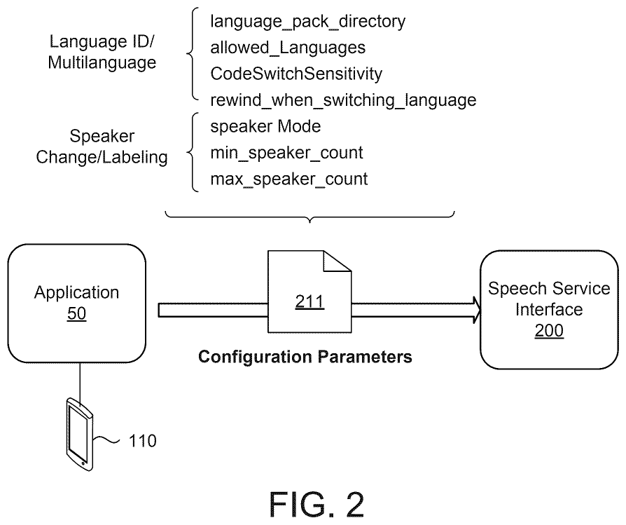

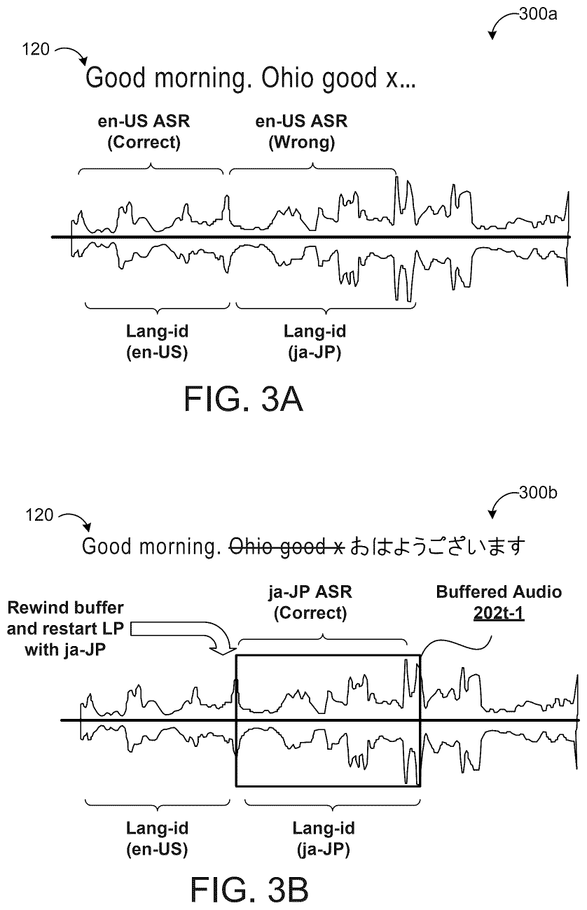

FIG. 3A provides a schematic view 300a of an example transcription 120 of an utterance transcribed from audio data 102 using a first speech recognition model for a first language after a switch to a second language is detected. Here, the first speech recognition model may include a resource in a first language pack for recognizing speech in English and the Unites States locale. A first portion of the utterance may be spoken in English where the first speech recognition model for the first language of English correctly transcribes the utterance in English. Here, the language ID predictor model 230 outputs a language ID event 232 that predicts the language code en-US for the first portion of the utterance. A second portion of the utterance spoken in Japanese is processed by the language ID predictor model 230 to output a language ID event 232 that predicts the language code ja-JP. Assuming that the language ID event 232 results in a switching decision to a new language, FIG. 3A shows the first speech recognition model for the first language of English processing the second portion of the utterance spoken in Japanese resulting in the recognition of words in the wrong language. This is the result of the time delay that occurs for a new language pack including a second speech recognition model for the second language of Japanese to successfully load. That is, while the new language pack including the correct speech recognition model is loading, the MSS 250 may continue to use the previously loaded language pack, thereby resulting in recognition of words in an incorrect language.

FIG. 3B is a schematic view of the example transcription of FIG. 3A corrected by rewinding buffered audio data to a time when the speech for the different second language was detected in the audio data. Here, the speech service interface 200 retrieves the buffered audio data rewound to the appropriate location, whereby the second speech recognition for the second language of Japanese commences processing of the burferred audio data once the new language pack is successfully loaded. Accordingly, the MSS 250 may accurately transcribe the second portion of the utterance spoken in Japanese by performing speech recognition on the rewound buffered audio data using a second speech recognition model for the second language.

Referring back to FIG. 1B, the speech service interface 200 may further output streaming events 124 that indicate speaker turn locations and/or diarization results output by the MSS. As described above with reference to FIG. 2, the configuration parameters 211 may specify the speaker mode of speaker change or speaker labeling. The speaker turn locations in the streaming events may indicate locations in the transcription where speaker change events are detected by the speaker change/labeling model 280. Similarly, the diarization results in the streaming events 124 may annotate portions of a transcription of a multi-speaker dialogue with appropriate speaker labels.

Notably, diarization results improve as more audio data 102 is processed by the speaker change/labeling model 280. As a result, the speech service interface 200 may emit correction events 126 that provide corrections to previously emitted diarization results. Here, the correction events may list hypothesis parts, i.e., portion of a transcription previously annotated with speaker labels, that require correction based on improved diarization results output by the speaker change/labeling model 280. The application 50 may calculate an absolutes alignment of the hypotheses parts that require correction and updating the speaker labels with the correct labels.

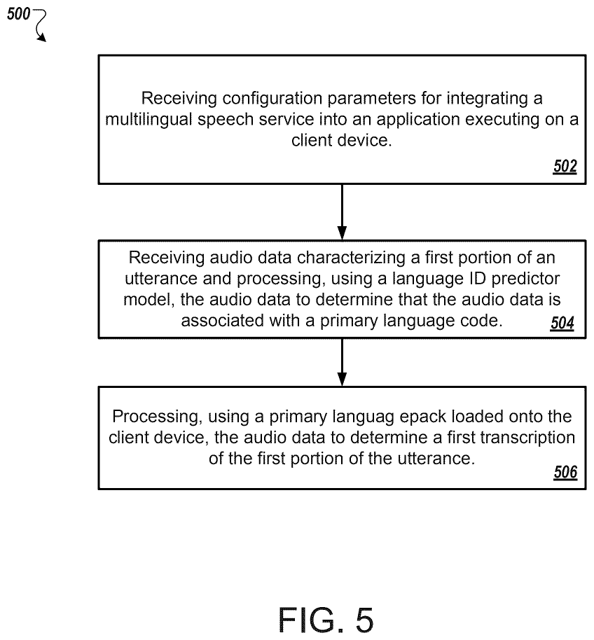

FIG. 5 is a schematic view of an example flowchart for an exemplary arrangement of operations for a method 500 of integrating a multilingual speech service 250 into an application 50 executing on a client device 110. The operations may execute on data processing hardware 112 of the client device 110 based on instructions stored on memory hardware 114 of the client device 110. At operation 502, the method includes receiving, from the application 50, at a speech service interface 200, configuration parameters 211 for integrating the multilingual speech service 250 into the application 50. The configuration parameters 211 include a language pack directory 225 that maps a primary language code 235 to an on-device path of a primary language pack 210 of the multilingual speech service 250 to load onto the client device 110 for use in recognizing speech directed toward the application 50 in a primary language specified by the primary language code 235. The language pack directory 225 also maps each of one or more codeswitch language codes 235 to an on-device path of a corresponding candidate language pack 210. Each corresponding candidate language pack is configured to recognize speech after a switch to a respective particular language specified by the corresponding codeswitch language code 235 is detected by a language identification (ID) predictor model 230.

At operation 504, the method 500 also includes receiving audio data 102 characterizing a first portion of an utterance 106 directed toward the application 50 and processing, using the language ID predictor model 230, the audio data 102 to determine that the audio data 102 is associated with the primary language code 210, thereby specifying that the first portion of the utterance 106 includes speech spoken in the primary language.

At operation 506, based on the determination that the audio data 102 is associated with the primary language code 235, the method 500 also includes processing, using the primary language pack 210 loaded onto the client device 110, the audio data 102 to determine a first transcription 120 of the first portion of the utterance 106. The first transcription 120 includes one or more words in the primary language.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory

(EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

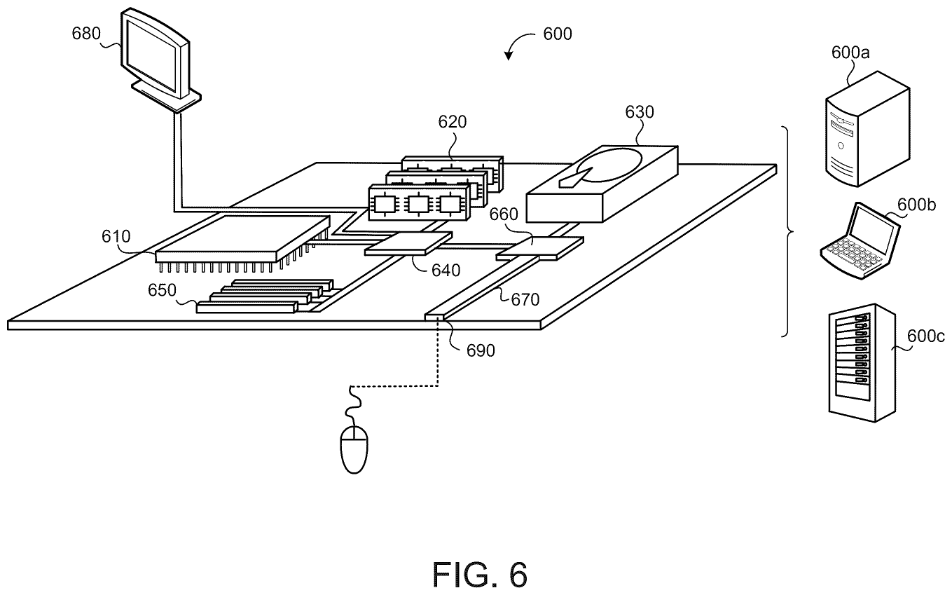

FIG. 6 is schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

1. A computer-implemented method executed on data processing hardware of a client device that causes the data processing hardware to perform operations comprising:
receiving, from an application executing on the client device, at a speech service interface, configuration parameters for integrating a multilingual speech service into the application, the configuration parameters comprising a language pack directory that maps:
a primary language code to an on-device path of a primary language pack of the multilingual speech service to load onto the client device for use in recognizing speech directed toward the application in a primary language specified by the primary language code; and
each of one or more codeswitch language codes to an on-device path of a corresponding candidate language pack, each corresponding candidate language pack configured to recognize speech after a switch to a respective particular language specified by the corresponding codeswitch language code is detected by a language identification-(ID) predictor model;
receiving audio data characterizing a first portion of an utterance directed toward the application;
processing, using the language ID predictor model, the audio data to determine that the audio data is associated with the primary language code, thereby specifying that the first portion of the utterance includes speech spoken in the primary language; and
based on the determination that the audio data is associated with the primary language code, processing, using the primary language pack loaded onto the client device, the audio data to determine a first transcription of the first portion of the utterance, the first transcription comprising one or more words in the primary language.

2. The method of claim 1, wherein, after processing the audio data to determine the first transcription, the operations further comprise:
receiving additional audio data characterizing a second portion of the utterance directed toward the application;
processing, using the language ID predictor model, the additional audio data to determine that the additional audio data is associated with a corresponding one of the one or more codeswitch language codes, thereby specifying that the second portion of the utterance includes speech spoken in the respective particular language specified by the corresponding codeswitch language code; and
based on the determination that the additional audio data is associated with the corresponding codeswitch language code:
determining that the additional audio data includes a switch from the primary language to the respective particular language specified by the corresponding codeswitch language code associated with the additional audio data;
based on determining that the additional audio data includes the switch from the primary language to the respective particular language, loading, from memory hardware of the client device, using the language pack directory that maps the corresponding codeswitch language code to the on-device path of the corresponding candidate language pack, the corresponding candidate language pack onto the client device for use by the multilingual speech service in recognizing speech in the respective particular language; and
processing, using the corresponding candidate language pack loaded onto the client device, the additional audio data to determine a second transcription of the second portion of the utterance, the second transcription including one or more words in the respective particular language specified by the corresponding codeswitch language code associated with the additional audio data.

3. The method of claim 1, wherein the configuration parameters further comprise a rewind audio buffer parameter that causes an audio buffer to rewind buffered audio data for use by the corresponding candidate language pack after the switch to the particular language specified by the corresponding codeswitch language code is detected by the language ID predictor model.

4. The method of claim 1, wherein the configuration parameters further comprise a list of allowed languages that constrains the language ID predictor model to only predict language codes that specify languages from the list of allowed languages.

5. The method of claim 1, wherein the configuration parameters further comprise a codeswitch sensitivity indicating a confidence threshold that a probability score for a new language code predicted by a language identification (ID) predictor model must satisfy in order for the speech service interface to attempt to switch to a new language pack for recognizing speech in a language specified by the new language code.

6. The method of claim 1, wherein each language code and each of the one or more codeswitch language codes specify a respective language and a respective locale.

7. The method of any of claim 6, wherein:
the one or more codeswitch language codes comprise a plurality of codeswitch language codes; and
the respective particular language specified by each codeswitch language code in the plurality of codeswitch language codes is different than the respective particular language specified by each other codeswitch language code in the plurality of codeswitch language codes.

8. The method of claim 1, wherein the primary language pack and each corresponding candidate language pack comprises at least one of:
an automated speech recognition (ASR) model;
parameters/configurations of the ASR model;
an external language model;
neural network types;
an acoustic encoder;
components of a speech recognition decoder; or
the language ID predictor model.

9. The method of claim 1, wherein the configuration parameters further comprise a speaker change detection mode that causes the multilingual speech service to detect locations of speaker turns in input audio for integration into the application.

10. The method of claim 1, wherein the configuration parameters further comprise a speaker label mode that causes the multilingual speech service output diarization results for integration into the application, the diarization results annotating a transcription of utterances spoken by multiple speakers with respective speaker labels.

11. A system comprising:
data processing hardware; and
memory hardware storing instructions that when executed on the data processing hardware causes the data processing hardware to perform operations comprising:
receiving, from an application executing on the client device, at a speech service interface, configuration parameters for integrating a multilingual speech service into the application, the configuration parameters comprising a language pack directory that maps:
a primary language code to an on-device path of a primary language pack of the multilingual speech service to load onto the client device for use in recognizing speech directed toward the application in a primary language specified by the primary language code; and
each of one or more codeswitch language codes to an on-device path of a corresponding candidate language pack, each corresponding candidate language pack configured to recognize speech after a switch to a respective particular language specified by the corresponding codeswitch language code is detected by a language identification-(ID) predictor model;
receiving audio data characterizing a first portion of an utterance directed toward the application;
processing, using the language ID predictor model, the audio data to determine that the audio data is associated with the primary language code, thereby specifying that the first portion of the utterance includes speech spoken in the primary language; and
based on the determination that the audio data is associated with the primary language code, processing, using the primary language pack loaded onto the client device, the audio data to determine a first transcription of the first portion of the utterance, the first transcription comprising one or more words in the primary language.

12. The system of claim 11, wherein, after processing the audio data to determine the first transcription, the operations further comprise:
receiving additional audio data characterizing a second portion of the utterance directed toward the application;
processing, using the language ID predictor model, the additional audio data to determine that the additional audio data is associated with a corresponding one of the one or more codeswitch language codes, thereby specifying that the second portion of the utterance includes speech spoken in the respective particular language specified by the corresponding codeswitch language code; and
based on the determination that the additional audio data is associated with the corresponding codeswitch language code:
determining that the additional audio data includes a switch from the primary language to the respective particular language specified by the corresponding codeswitch language code associated with the additional audio data;
based on determining that the additional audio data includes the switch from the primary language to the respective particular language, loading, from memory hardware of the client device, using the language pack directory that maps the corresponding codeswitch language code to the on-device path of the corresponding candidate language pack, the corresponding candidate language pack onto the client device for use by the multilingual speech service in recognizing speech in the respective particular language; and
processing, using the corresponding candidate language pack loaded onto the client device, the additional audio data to determine a second transcription of the second portion of the utterance, the second transcription including one or more words in the respective particular language specified by the corresponding codeswitch language code associated with the additional audio data.

13. The system of claim 11, wherein the configuration parameters further comprise a rewind audio buffer parameter that causes an audio buffer to rewind buffered audio data for use by the corresponding candidate language pack after the switch to the particular language specified by the corresponding codeswitch language code is detected by the language ID predictor model.

14. The system of claim 11, wherein the configuration parameters further comprise a list of allowed languages that constrains the language ID predictor model to only predict language codes that specify languages from the list of allowed languages.

15. The system of claim 11, wherein the configuration parameters further comprise a codeswitch sensitivity indicating a confidence threshold that a probability score for a new language code predicted by a language identification (ID) predictor model must satisfy in order for the speech service interface to attempt to switch to a new language pack for recognizing speech in a language specified by the new language code.

16. The system of claim 11, wherein each language code and each of the one or more codeswitch language codes specify a respective language and a respective locale.

17. The system of any of claim 16, wherein:
the one or more codeswitch language codes comprise a plurality of codeswitch language codes; and
the respective particular language specified by each codeswitch language code in the plurality of codeswitch language codes is different than the respective particular language specified by each other codeswitch language code in the plurality of codeswitch language codes.

18. The system of claim 11, wherein the primary language pack and each corresponding candidate language pack comprises at least one of:
an automated speech recognition (ASR) model;
parameters/configurations of the ASR model;
an external language model;
neural network types;
an acoustic encoder;
components of a speech recognition decoder; or the language ID predictor model.

19. The system of claim 11, wherein the configuration parameters further comprise a speaker change detection mode that causes the multilingual speech service to detect locations of speaker turns in input audio for integration into the application.

20. The system of claim 11, wherein the configuration parameters further comprise a speaker label mode that causes the multilingual speech service output diarization results for integration into the application, the diarization results annotating a transcription of utterances spoken by multiple speakers with respective speaker labels.
